(19) United States
(12) Patent Application Publication
(10) Pub. No.: US 2026/0212362 A1
(43) Pub. Date: Jul. 23, 2026

(54) SYSTEM AND METHOD FOR REAL-TIME ONLINE REVIEW FRAUD DETECTION USING FRAUD-AWARE SELECTIVE ATTENTION WITH MULTI-TIER VERIFICATION

(71) Applicant: ÖNDER LEVENTOGLU, IZMIR (TR)

(72) Inventor: ÖNDER LEVENTOGLU, IZMIR (TR)

(21) Appl. No.: 19/315,565

(22) Filed: Aug. 31, 2025

(51) Int. Cl. G06Q 20/40; G06Q 10/10

(52) U.S. Cl. CPC G06Q 20/4016; G06Q 10/10; G06Q 20/40

(57) ABSTRACT

A system and method for real-time detection of fraudulent online reviews using fraud-aware selective attention that allocates computation according to a fraud probability density over textual segments and metadata. Calibrated confidence, adapted to platform base rates, enables dynamic routing among lightweight models, complex models, and a multi-tier human review path. Coordinated fraud is detected by aggregating temporal, textual, network, and behavioral features into a coordination score. Verification outcomes are committed as incremental Merkle proofs with batched anchoring to a ledger without storing personally identifiable information, providing audit-suitable evidence for regulatory compliance. The system supports pre-publication intervention at production scale with configurable latency and accuracy targets, operates as an independent verifier using publicly accessible data, and emits compliance reports and risk metrics for businesses, regulators, and insurers. Alternative embodiments may include different calibration methods, indicator sets, model families, and ledger implementations.

### CROSS-REFERENCE TO RELATED APPLICATIONS

None.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### STATEMENT REGARDING PRIOR DISCLOSURES BY THE INVENTOR OR A JOINT INVENTOR

Not Applicable.

Definitions (adds-only). As used herein, a “publish-gate” is a machine-enforced decision point that refuses publication unless a verifiable proof bundle is present. A “proof bundle” comprises artifacts sufficient to validate that: (i) identity-related status associated with the submitting account is acceptable, (ii) transaction-related compliance evidence satisfies a policy, and (iii) a device-originated presence attestation is fresh within a policy window. Mechanisms that produce such artifacts may be issued by external verifiers and are treated by the system as opaque inputs.

External verification vector (adds-only). The decision pipeline accepts an external verification vector V={v1, v2, v3}, where each element is a signed token or proof issued by an independent verifier. The pipeline evaluates V in a specified processing-stage order and constructs a stage-ordered hash chain over intermediate states; any mismatch in order or content invalidates the chain and the submission is refused.

Refusal & receipt binding (adds-only). In embodiments, the system refuses publication unless a pre-publication verification step validates (a) the stage-ordered chain for the current submission and (b) acceptance of V under a policy. Upon acceptance, the system binds the decision into a receipt that includes the canonical representation, per-stage digests, and a policy identifier and version, and emits a batch commitment (e.g., a Merkle root) that enables per-item inclusion proofs without exposing other batch elements.

Terms of degree (adds-only). As used herein, “fresh” denotes a token whose signer-asserted time falls within a policy-defined acceptance window; “proximate” denotes satisfaction of a policy-defined proximity category without disclosure of raw coordinates; and “low latency” denotes SLO-bounded processing consistent with the pipeline's stated targets.

### SEQUENCE LISTING

Not Applicable.

### BACKGROUND OF THE INVENTION

### (1) Field of the Invention

The invention relates to computerized systems for detecting fraudulent content in online review platforms and, more particularly, to real-time verification using fraud-aware selective attention, platform-calibrated confidence, multi-tier processing (automated and human), and cryptographic proof generation suitable for regulatory compliance.

### (2) Description of Related Art Including Information Disclosed Under 37 CFR 1.97 and 1.98

Online review fraud materially distorts consumer decisions and market integrity. Regulatory frameworks, including FTC Rule 16 CFR Part 465 (effective Oct. 21, 2024) and the EU Digital Services Act, Regulation (EU) 2022/2065 (effective Feb. 17, 2024), heighten enforcement obligations and penalties, creating a need for accurate, scalable, real-time verification.

Review fraud presents challenges distinct from generic text classification: (i) coordinated campaigns within tight temporal windows; (ii) incentivized reviews using subtle disclosure; (iii) review farms operating cross-platform with templated variants; (iv) obfuscation (Unicode tricks, stylometry shifts); and (v) real-time intervention requirements.

Representative prior art includes rule-based filters and sentiment classifiers, as well as blockchain storage of ratings without verification. Such approaches typically lack multi-factor fraud indicators, platform-aware calibration, dynamic resource allocation, or cryptographically anchored auditability, and often fail to meet latency/throughput targets required for pre-publication intervention.

Any references to “prior art,” “conventional,” or “existing” systems are provided for context and are not an admission that such material is prior art under 35 U.S.C. § 102 or § 103 with respect to any claim of this application.

Standard transformer models provide strong text understanding but, when naively applied, incur uniform attention and quadratic costs, limiting sub-50 ms latency at scale.

Accordingly, there is a need for a fraud-aware architecture that concentrates computation where suspicious signals are dense, calibrates confidence to platform baselines, orchestrates human reviewers when necessary, and emits tamper-resistant proofs.

### BRIEF SUMMARY OF THE INVENTION

The invention provides a computer-implemented method and system for real-time review fraud detection based on four synergistic innovations:

Fraud-Aware Selective Attention (FASA): A mechanism that computes fraud probability density (FPD) over text and metadata and allocates attention granularity accordingly (fine-grained for suspicious spans; coarser for benign spans), reducing compute while improving detection sensitivity.

Platform-Calibrated Confidence Routing: Confidence calibration (e.g., temperature scaling) tuned to platform-specific base rates, enabling dynamic routing among lightweight models, complex models, and human expert tiers based on calibrated thresholds.

Algorithmic Human-AI Orchestration: A multi-tier reviewer framework with algorithmic assignment that considers fraud-type expertise, response SLAs, accuracy history, and load balancing to guarantee timely escalation.

Incremental Cryptographic Proofs: Incremental Merkle tree construction with cached nodes enabling O(log n) updates and privacy-preserving anchoring for auditability and regulatory reporting.

In combination, these components achieve high accuracy with pre-publication intervention at production-scale throughput.

### BRIEF DESCRIPTION OF THE DRAWINGS

FIG. 1 shows an architecture from review ingestion through FASA, platform-calibrated confidence, multi-tier routing, fraud detection, human orchestration, cryptographic proof generation, and output.

FIG. 2 depicts FASA: FPD computation, variable segment sizing, and selective compute allocation.

FIG. 3 shows confidence calibration (temperature scaling, ECE minimization), platform adjustments, and dynamic thresholds.

FIG. 4 illustrates human-AI orchestration: reviewer tiers, assignment algorithm, work-stealing queues, and capacity planning.

FIG. 5 depicts fraud pipelines: temporal clustering, text similarity, network proximity, and coordinated campaign identification.

FIG. 6 shows incremental Merkle construction with cached nodes and smart-contract anchoring.

FIG. 7 illustrates trust scoring and threshold-based interventions.

FIG. 8 shows validated performance distributions (latency/accuracy/throughput).

### DETAILED DESCRIPTION OF THE INVENTION

### Definitions

“Review” includes textual content, rating, and associated metadata; “Platform” includes any service hosting reviews; “Fraud” includes coordinated or deceptive manipulation; “Confidence” denotes calibrated probability of correctness; “Proof” denotes a cryptographic artifact anchoring verification without revealing personally identifiable information (PII); “Pre-publication” means before the review becomes visible to users or ingested by ranking/recommendation pipelines. As used herein, “or” is inclusive (A or B means A, B, or A and B). “Comprising” is open-ended.

### Notation

For avoidance of encoding issues, Σ may be read as “sum over i,” × as “multiplied by,” and √d as “square root of d”; equations may be expressed equivalently in ASCII as needed.

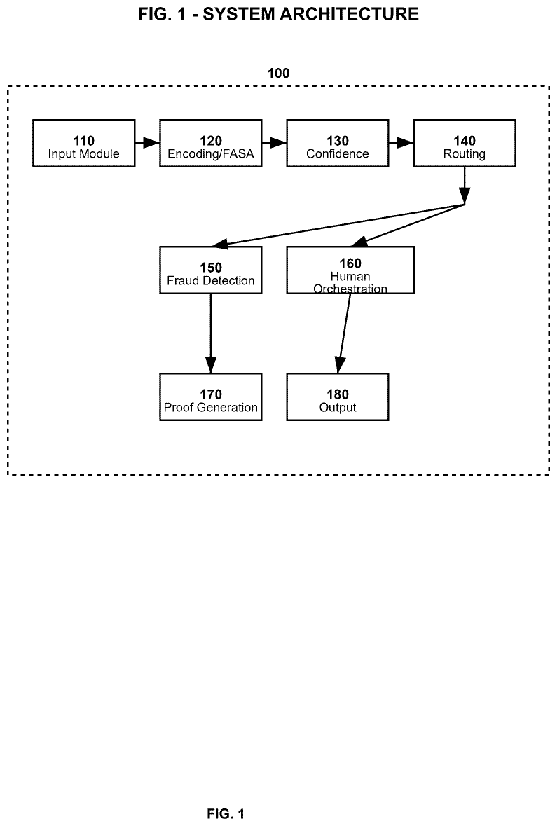

### System Overview (FIG. 1)

A system 100 includes: input module 110; encoding with FASA 120; confidence module 130; routing module 140; fraud detection module 150; human orchestration module 160; proof generation module 170; and output module 180. Components may be co-located or distributed.

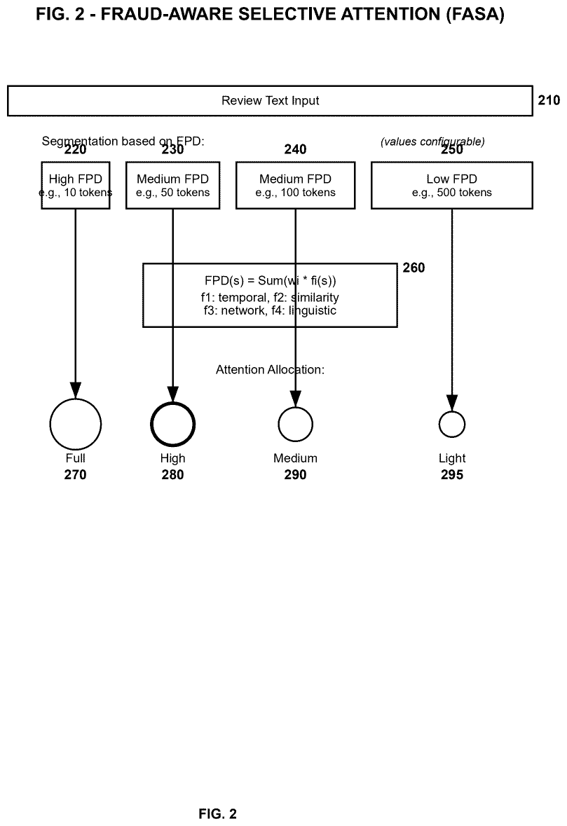

### Fraud-Aware Selective Attention (FIG. 2)

The system computes FPD(s)=Σwᵢfᵢ(s) across indicators, where each fᵢ represents a specific fraud signal: f₁=temporal velocity (exp(−Δt/t) measuring time between reviews); f₂=text similarity (cosine similarity to recent reviews); f₃=network proximity (binary for same/24 subnet or decay function for network distance); f₄=linguistic anomaly (perplexity ratio to baseline); f₅=rating deviation (normalized distance from expected rating); f₆=metadata consistency (device entropy relative to baseline); f₇=incentive markers (pattern match density); and f₈=reviewer history (ratio of suspicious to total reviews). Segment granularity dynamically varies from 10 tokens (for FPD>0.8, indicating high fraud probability) to 500 tokens (for FPD<0.2, indicating low fraud probability), with intermediate granularities of, for example, 50, 100, and 200 tokens for intermediate FPD values. This adaptive segmentation ensures suspicious spans receive fine-grained attention while benign spans receive coarser processing, departing from uniform attention by adapting compute to fraud likelihood, yielding both higher recall and lower cost.

Indicators can be normalized and weighted by learned parameters; weights may be trained via gradient-based optimization on labeled datasets. Alternative embodiments may use CNNs, RNNs, or graph attention for the selective mechanism.

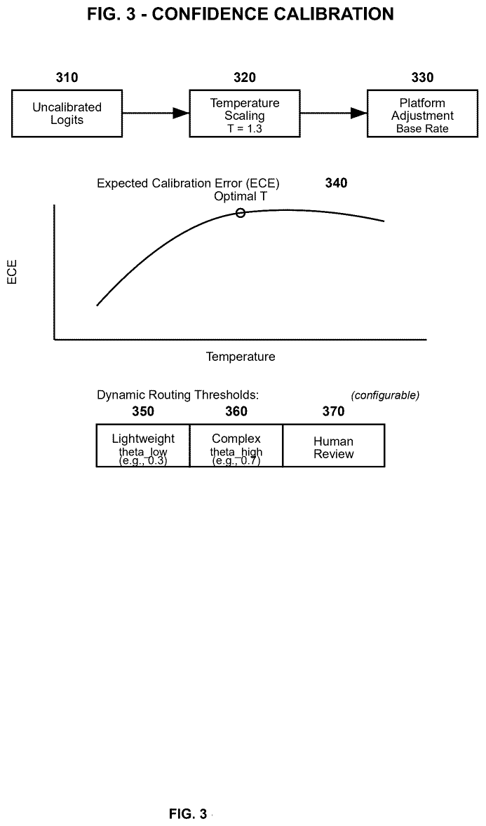

### Platform-Calibrated Confidence and Dynamic Routing (FIG. 3)

Uncalibrated model logits are adjusted via temperature scaling or equivalent calibration to minimize Expected Calibration Error (ECE) on platform-specific validation sets. Calibrated confidence is compared to configurable thresholds to choose among: (i) lightweight model path; (ii) complex model path; or (iii) human escalation. Thresholds are dynamically adjusted in response to live metrics (e.g., false-positive drift, queue depth) to meet SLAs.

### Training and Calibration Data

In embodiments, indicator weights and calibration parameters are estimated from labeled datasets comprising confirmed legitimate and fraudulent reviews obtained from publicly available corpora, voluntary business submissions, crowdsourced annotations with consensus aggregation, and synthetic pattern variants. Platform-specific calibration uses held-out validation sets to tune temperature or isotonic parameters. Datasets and parameters are implementation-dependent and non-limiting.

### Drift Handling

A drift detector (e.g., population stability index, KL divergence, or MMD) monitors feature and outcome distributions. When drift exceeds a configurable threshold, the system automatically recalibrates (e.g., re-tunes temperature/isotonic parameters), adjusts routing thresholds, and/or re-estimates indicator weights using fresh labeled or pseudo-labeled data.

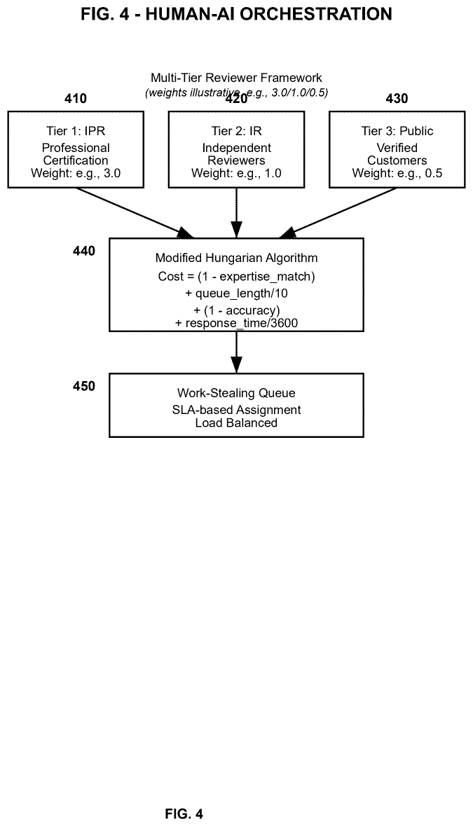

### Human-AI Orchestration (FIG. 4)

The system supports multi-tier human reviewers with algorithmic assignment considering: expertise vectors by fraud type, accuracy history, response-time SLAs, and load balancing (e.g., work-stealing). A modified assignment (e.g., Hungarian-based with constraints) optimizes cost under SLA and quality constraints.

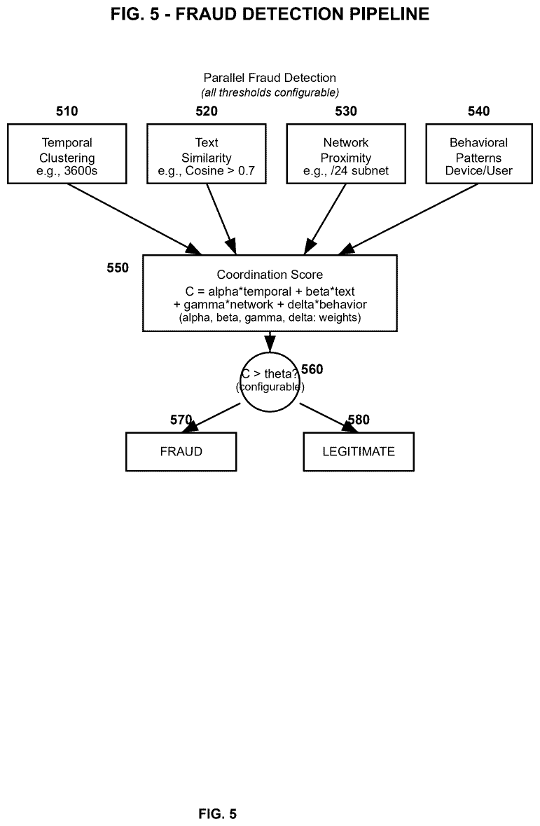

### Fraud Detection Pipeline (FIG. 5)

The pipeline operates in parallel: (i) temporal clustering (burst windows, sliding window rates), (ii) text similarity (embedding-based similarity), (iii) network proximity (subnet, ASN, geolocation), (iv) behavioral correlation (device/user patterns). A coordination score aggregates features to flag campaigns.

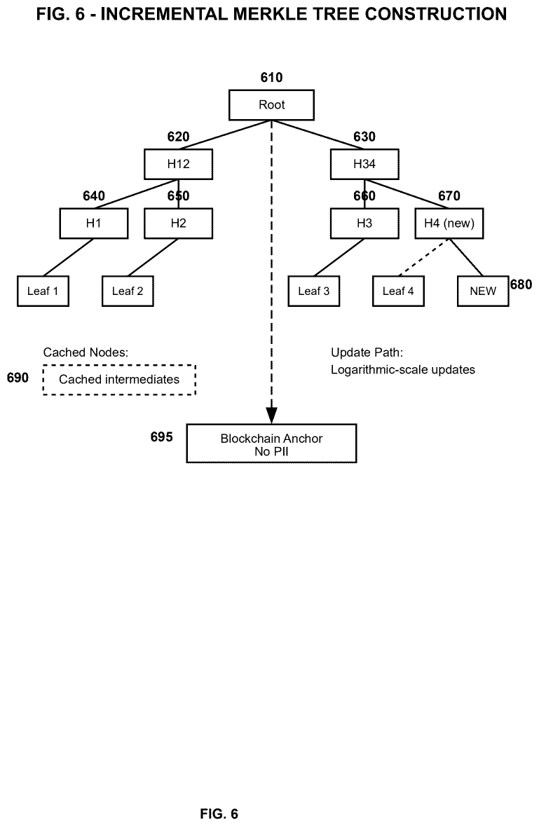

### Incremental Cryptographic Proofs (FIG. 6)

Verification results (review hash, outcomes, signals, timestamps, optional confidence) are added as leaves to an incremental Merkle tree with cached intermediates, enabling O(log n) path updates and batched anchoring. Anchoring may occur on public or permissioned ledgers; no PII is stored on-chain. Selective disclosure is supported by sharing only proof paths.

### Computer Functionality Improvements

The disclosed fraud-aware selective attention reduces computational complexity by allocating token-level processing non-uniformly as a function of fraud probability density, decreasing memory bandwidth, attention FLOPs, and tail latency versus uniform attention.

Incremental Merkle proofs with cached intermediates reduce update cost from linear to O(log n) per insertion, improving write-amortization for audit logs. These architectural changes improve computer performance itself (latency, throughput, cache locality), not merely a business workflow.

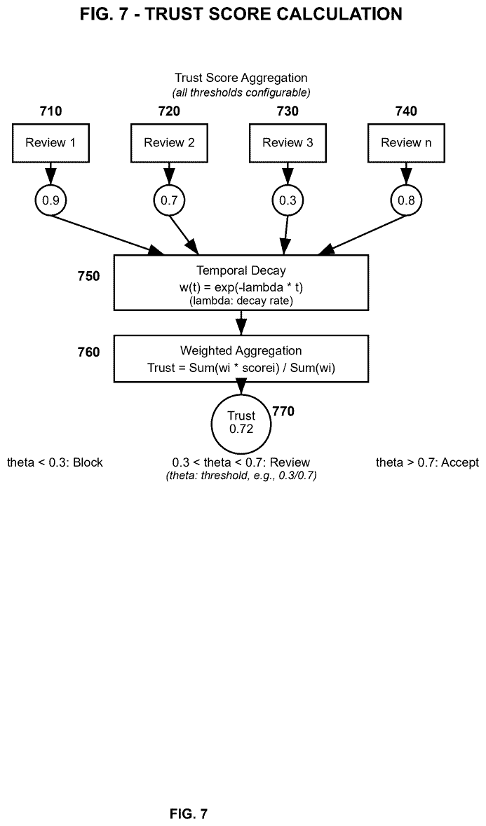

### Trust Scoring (FIG. 7)

In embodiments, a trust score is computed as a normalized aggregation of verified review outcomes with optional temporal decay and reviewer weighting. Thresholds can trigger interventions or surface indicators.

### Certification Indicator

In embodiments, a certification indicator (e.g., badge or signed token) is produced responsive to a verification result or trust-score threshold. The indicator is digitally signed using a platform or service key (e.g., ECDSA or EdDSA) and includes a timestamp and nonces to prevent replay. Indicators are verifiable off-platform and revocable by publishing a revocation list or status endpoint upon later detection of coordinated fraud.

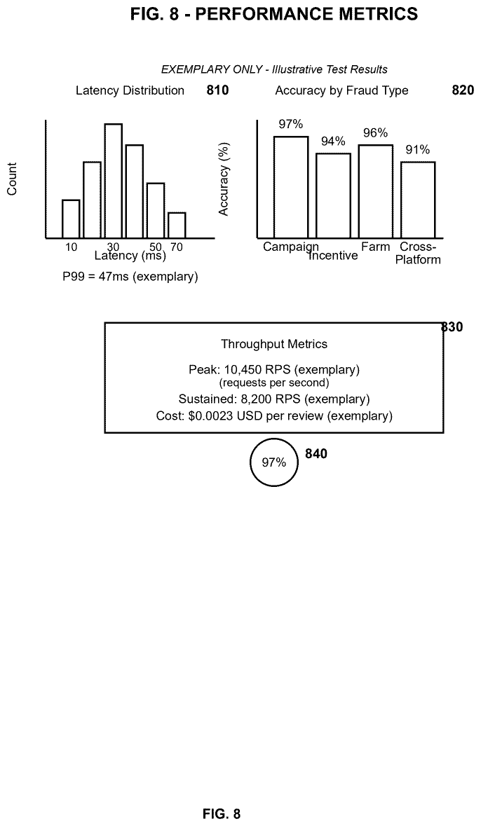

### Performance, Robustness, and Scale (FIG. 8)

The system supports pre-publication decisions with tail latency below target thresholds through: vectorized preprocessing; parallel indicator computation; dynamic batching; caching; and fallback paths (e.g., escalation on timeouts). Error handling includes GPU OOM recovery, degraded-mode fallbacks, and queue-based escalation.

### Resource-Aware Scheduling

In embodiments, the selective-attention allocator enforces a token-processing budget per review or batch to meet a latency target. Segment granularities are optimized (e.g., knapsack or bandit heuristic) to maximize expected fraud-gain subject to the budget, with spillover routed to a lower-cost path or deferred to human review under SLA rules.

### Commercial Implementation & Independence

The system may operate as an independent third-party verification service using publicly accessible data, providing verification outputs and regulatory compliance reports for businesses and regulators, and risk metrics for insurers. Monetization may include subscription access, per-verification pricing, and reporting services.

### Regulatory Interfaces

In embodiments, an output interface exposes programmatic reports (e.g., JSON over HTTPS, webhooks) comprising per-review proofs, aggregate metrics (counts, rates, distributions), and audit trails suitable for regulatory submissions and third-party verification.

### Alternative Embodiments

Models may be multilingual; selective attention may incorporate graph-structured signals; proofs may use alternative hash functions; calibration may use isotonic regression; and routing may include additional tiers or specialized detectors. As used herein, ‘Merkle tree’ encompasses hash-based authenticated data structures that provide per-leaf inclusion proofs; specific hash functions and node fan-out are implementation-dependent.

### Disclaimers

Numerical values (e.g., segment sizes, ECE targets, latencies) and hardware examples are non-limiting and may be configured across ranges. No claim element is intended as means-plus-function unless explicitly stated with “means.”

### LIST OF REFERENCE NUMERALS

100 System
110 Input module
120 Encoding with FASA
130 Confidence module
140 Routing module
150 Fraud detection module
160 Human orchestration module
170 Proof generation module
180 Output module

1. A computer-implemented method for real-time detection of fraudulent online reviews, comprising: receiving review data comprising text content and associated metadata; computing, for segments of the text content, a fraud probability density based on a plurality of fraud indicators; selectively allocating computational attention across the segments as a function of the fraud probability density, wherein segments having higher fraud probability density receive finer-grained processing than segments having lower fraud probability density; calibrating model confidence using a calibration procedure to produce a platform-calibrated confidence score; routing the review data among a plurality of processing paths based at least on the platform-calibrated confidence score, the plurality comprising at least a lightweight model path, a higher-complexity model path, and a human review path; detecting coordinated fraud by aggregating temporal, textual, network, and behavioral features into a coordination score; generating a cryptographic proof of verification by inserting a leaf corresponding to the review into a Merkle tree and computing an updated root; and outputting a verification result prior to publication of the review on a platform.

2. The method of claim 1, wherein the fraud indicators comprise at least one of: temporal velocity, text similarity to recent reviews, network proximity, linguistic anomaly, rating deviation, metadata consistency, incentive markers, and reviewer history, each weighted by learned parameters.

3. The method of claim 1, wherein the calibration procedure comprises temperature scaling or an equivalent calibration technique adapted to platform-specific base rates and configured to reduce calibration error below a predetermined threshold.

4. The method of claim 1, wherein routing thresholds are dynamically adjustable in response to live performance metrics including one or more of false-positive rate, queue depth, or service-level targets.

5. The method of claim 1, wherein the human review path comprises a multi-tier reviewer framework, and reviewer assignment is determined by an algorithm that accounts for expertise match to suspected fraud type, response-time constraints, historical accuracy, and load balancing.

6. The method of claim 1, wherein detecting coordinated fraud comprises identifying temporal clusters, computing embedding-based text similarity, determining network proximity, and computing a coordination score that exceeds a configurable threshold.

7. The method of claim 1, wherein generating the cryptographic proof comprises incrementally updating cached internal nodes of the Merkle tree to achieve a number of node updates that increases logarithmically with the number of leaves and anchoring a batch root to a blockchain or distributed ledger without storing personally identifiable information.

8. The method of claim 1, further comprising issuing regulatory-grade reports including verification outcomes, fraud signal summaries, and cryptographic proofs suitable for auditability.

9. The method of claim 1, wherein performance targets comprise meeting a configured percentile latency threshold for pre-publication intervention and a selected accuracy threshold on instrumented datasets.

10. The method of claim 1, wherein the method operates using publicly accessible review data without requiring privileged integration with the review platform.

11. A system for real-time online review fraud detection, comprising one or more processors and non-transitory memory storing instructions which, when executed, cause the system to: receive review data; compute fraud probability density over text segments using a plurality of indicators; apply fraud-aware selective attention that allocates fine-grained processing to higher-probability segments and coarser processing to lower-probability segments; calibrate model confidence to obtain a platform-calibrated confidence score; route processing among at least a lightweight model, a higher-complexity model, and a human review tier based on the calibrated confidence; detect coordinated fraud using temporal, textual, network, and behavioral features; generate incremental Merkle-based proofs of verification; and emit verification results prior to review publication.

12. The system of claim 11, wherein the human review tier comprises multiple certification levels, and an assignment component matches reviews to reviewers based on expertise vectors, response-time objectives, and accuracy histories.

13. The system of claim 11, wherein selective attention reduces computational cost relative to uniform attention while improving detection performance on coordinated campaigns.

14. The system of claim 11, further comprising an output interface to deliver compliance reports and risk metrics to businesses, regulators, or insurers.

15. The system of claim 11, wherein the system is deployable as an independent third-party verification service operating on publicly accessible data sources.

16. A non-transitory computer-readable storage medium storing instructions that, when executed by at least one processor, cause a system to perform operations comprising: computing fraud probability density over review text and metadata; allocating processing granularity across segments as a function of the density; calibrating confidence and routing among multiple processing paths including a human path; detecting coordinated fraud using aggregated features; incrementally generating Merkle proofs with batched anchoring; and providing verification results and audit-suitable reports for regulatory compliance.

17. The non-transitory computer-readable storage medium of claim 16, wherein the operations further comprise dynamically adjusting routing thresholds based on live error metrics and queue conditions.

18. The non-transitory computer-readable storage medium of claim 16, wherein the operations further comprise operating without privileged platform interfaces by processing publicly accessible review information.

19. The method of claim 1, further comprising maintaining fallback strategies to ensure continuity of verification results upon component degradation, including escalation to human review under timeouts or resource contention.

20. The system of claim 11, wherein cryptographic proofs support selective disclosure by providing path proofs for individual reviews without revealing other elements of a batch.

21. The method of claim 1, further comprising generating a digitally signed certification indicator responsive to the verification result or a trust score threshold, the indicator being displayable on third-party platforms and revocable upon subsequent detection of coordinated fraud.

22. The system of claim 11, wherein the output interface exposes programmatic reports including per-review proofs and aggregate compliance summaries via webhooks or APIs suitable for regulatory audits.

23. The non-transitory computer-readable storage medium of claim 16, wherein the operations further comprise producing fraud risk metrics for insurance underwriting or premium adjustment.

24. The method of claim 1, further comprising detecting distribution drift in incoming reviews and automatically updating at least one of the calibration parameters, routing thresholds, or indicator weights based on drift magnitude.

25. The system of claim 11, wherein the fraud-aware selective attention is configured to allocate a bounded token-processing budget across segments to satisfy a latency target while maximizing expected fraud detection gain.

26. The method of claim 1, wherein the cryptographic proof supports per-review path disclosure without revealing other batch elements, enabling verification by independent parties.

27. The method of claim 1, wherein the system enforces a specified processing-stage order, and each stage emits a cryptographic hash of its intermediate output, successive hashes forming a per-review hash chain; a mismatch in the chain indicates out-of-order or altered execution and invalidates the proof.

28. The method of claim 1, wherein device-integrity attestation and an on-device geofence produce a categorical proximity token selected from {AT_VENUE, NEARBY, REGIONAL} and no raw coordinates leave the device; the category is ingested as a feature or weight in fraud detection or trust scoring.

29. The method of claim 1, wherein a trust score computed with temporal decay triggers issuance or revocation of a digitally signed certification indicator, revocation being publicly verifiable via a revocation list or status endpoint.

30. A computer-implemented method comprising: receiving, from a client device, a review submission; normalizing the submission into a deterministic canonical form; processing the submission through a specified processing-stage order, each stage producing a digest chained to a prior stage; receiving an external verification vector comprising tokens issued by independent verifiers; refusing publication unless a pre-publication proof bundle verifies (a) validity of the stage-ordered digest chain and (b) acceptance of the external verification vector under a policy; and upon acceptance, constructing and anchoring a receipt that binds the canonical form, the stage digests, a policy identifier and version, and an indication of acceptance.

31. The method of claim 30, wherein the external verification vector comprises: (i) credential-status evidence indicating a reviewer tier and a current non-revoked state; (ii) a transaction-compliance proof that conveys purchase attributes without exposing personally identifiable information; and (iii) a device-originated presence attestation asserting a proximity category without disclosing raw geographic coordinates.

32. The method of claim 30, further comprising decision-time re-evaluation that denies publication if the credential-status evidence is revoked, the transaction-compliance proof falls outside a validity window, or the presence attestation is stale.

33. The method of claim 30, wherein the receipt records a policy identifier and version cryptographically bound to the canonical representation and exposes a verifier interface that enables per-item inclusion proofs without revealing other batch elements.

34. The method of claim 30, wherein anchoring comprises committing the receipt or a batch root to one or more append-only ledgers and adopting a policy that requires confirmations from at least a quorum before treating the receipt as finalized.

35. The method of claim 30, wherein the verifier interface exports a portable proof bundle comprising a subset of field-level digests, ledger anchoring metadata, and proof material sufficient for external validation.

36. The method of claim 30, further comprising computing a trust-score delta for an entity referenced by the submission and recording the delta within the receipt, and upon later revocation of the credential-status evidence transitioning the receipt lineage from accepted to revoked-effective-date.
